(19) United States
(12) Patent Application Publication
(10) Pub. No.: US 2020/0310652 A1
(43) Pub. Date: Oct. 1, 2020

(54) METHOD AND SYSTEM FOR SECURE DISTRIBUTED DATA MANAGEMENT OF DYNAMIC DATA

(71) Applicant: ELECTRONICS AND TELECOMMUNICATIONS RESEARCH INSTITUTE, Daejeon (KR)

(72) Inventors: Taek-Young YOUN, Daejeon (KR); Nam-Su JHO, Daejeon (KR); Dae-Sung MOON, Daejeon (KR); Ik-Kyun KIM, Daejeon (KR); Seung-Hun JIN, Daejeon (KR)

(21) Appl. No.: 16/794,377

(22) Filed: Feb. 19, 2020

(30) Foreign Application Priority Data
Mar. 29, 2019 (KR) 10-2019-0036997

(51) Int. Cl. G06F 3/06

(52) U.S. Cl. CPC G06F 3/065; G06F 3/067; G06F 3/0619

(57) ABSTRACT

A method for secure distributed data management for dynamic data includes segmenting original data into multiple pieces, generating state information pertaining to row-based data configured with data blocks, and generating additional information for recovering the state information and the row-based data. The data blocks, corresponding to the segmented data, are stored in data servers, and each of the data servers stores data blocks selected at an interval corresponding to the number of data servers in order to store the segmented data.

### CROSS REFERENCE TO RELATED APPLICATION

This application claims the benefit of Korean Patent Application No. 10-2019-0036997, filed Mar. 29, 2019, which is hereby incorporated by reference in its entirety into this application.

### BACKGROUND OF THE INVENTION

### 1. Technical Field

The present invention relates to a method and system for secure distributed data management for dynamic data.

### 2. Description of Related Art

As technology for protecting original data through data distribution, there are the most basic method in which the same data is concurrently stored in multiple servers and a method in which, even though some servers fail, damaged and incomplete data is recoverable from data of the remaining servers, such as in a RAID. However, the existing technology for protecting the original copy of data based on multiple servers is mostly designed for static data, thus being of limited usefulness as technology for an application environment in which dynamic data is used.

When an error has occurred in a single server, damaged data may be recovered using an error-correcting code (ECC) according to user requirements. Also, even though data is stored in multiple servers in a distributed manner, when part of data in individual servers is damaged, original data may be recovered using the ECC. However, when all of the data stored in a specific server is damaged, it is still impossible to respond thereto even though an ECC-based response method is used.

### DOCUMENTS OF RELATED ART

(Patent Document 1) Korean Patent Application Publication No. 10-2017-0077231, published on Jul. 5, 2017 and titled “Dynamic scaling of storage volumes for storage client file systems”
(Patent Document 2) Korean Patent Application Publication No. 10-2015-0079950, published on Jul. 8, 2015 and titled “Systems and methods for dynamic data storage”
(Patent Document 3) Korean Patent Application Publication No. 10-2018-0078991, published on Jul. 10, 2018 and titled “Real-time mass-data-processing system for automatically managing memory cache”
(Patent Document 4) U.S. patent Ser. No. 10/073,903, published on Sep. 11, 2018 and titled “Scalable database system for querying time-series data”.
(Non-Patent Document 1) C. C. Erway et al, “Dynamic Provable Data Possession”, ACM Transactions on Information and System Security, Volume 17, Issue 4, Article 15, PP. 1-29, April, 2015.

### SUMMARY OF THE INVENTION

An object of the present invention is to provide a method and system for distributed data management, which ensure the security of storage for storing data and guarantee the retrieval of the original copy of the data such that the availability of the data is prevented from being lowered due to stability in an application environment in which storage of the data is outsourced.

Another object of the present invention is to provide a method and system for distributed data management which provide update of data that is stored in a distributed manner when the stored data is dynamically changed.

A further object of the present invention is to provide a method and system for distributed data management which include a data-processing technique, such as data encoding, a technique for creating additional data, and an element algorithm for data update, such as addition, deletion, modification, and the like, in order to distribute and store data.

A method for secure distributed data management for dynamic data according to an embodiment of the present invention includes segmenting original data into multiple pieces, generating state information pertaining to row-based data configured with data blocks, and generating additional information for recovering the state information and the row-based data. The data blocks, corresponding to the segmented data, may be stored in data servers, and each of the data servers may store data blocks that are selected at an interval corresponding to the number of data servers in order to store the segmented data.

According to an embodiment, the state information may be stored in at least one state information server.

According to an embodiment, the state information may include flag information, which represents the state of the row-based data, and original-data information, which corresponds to the number of pieces of data corresponding to the original data, among the data stored in the data servers.

According to an embodiment, the flag information may be set to a bit ‘1’ when the row-based data includes no NULL data, and may be set to a bit ‘0’ when the row-based data includes NULL data.

According to an embodiment, the original-data information may include the number of pieces of NULL data, which are stored regardless of the original data in an update process.

According to an embodiment, the additional information may be stored in at least one additional-data server.

According to an embodiment, the method may further include requesting update corresponding to addition of a new data block or deletion or modification of any one of the data blocks.

According to an embodiment, the method may further include changing the data block of any one of the data servers into update data and updating the additional information so as to match the update data.

According to an embodiment, the method may further include requesting deletion of any one of the data blocks, storing the data of a data server adjacent to a data server corresponding to the data block, the deletion of which is requested, and storing NULL data in the last data server, among the data servers.

According to an embodiment, the method may further include requesting insertion of data into the row-based data.

According to an embodiment, the method may further include storing the data, the insertion of which is requested, in a data server in which the data is intended to be inserted when there is space to insert the data.

According to an embodiment, the method may further include, when there is no space to insert the data, the insertion of which is requested, storing the data in the data server in which the data is intended to be inserted and generating new row-based data in the data servers.

According to an embodiment, the method may further include removing noise in order to delete removable portions from accumulated pieces of NULL data.

According to an embodiment, removing the noise may be started when the number of pieces of NULL data in at least two of the data servers is equal to or greater than the number of data servers.

A distributed data management server according to an embodiment of the present invention includes at least one processor and memory for storing at least one instruction executed by the at least one processor. The at least one instruction may be executed by the at least one processor in order to segment original data into multiple pieces, to generate state information pertaining to row-based data configured with data blocks, and to generate additional information for recovering the state information and the row-based data. The data blocks, corresponding to the segmented data, may be stored in data servers. Each of the data servers may store data blocks selected at an interval corresponding to the number of data servers in order to store the segmented data.

A distributed data management server according to an embodiment of the present invention includes at least one processor and memory for storing at least one instruction executed by the at least one processor. The at least one instruction may be executed by the at least one processor in order to segment original data into multiple pieces, to generate state information pertaining to row-based data configured with data blocks, acquired from the segmented data and stored in respective data servers, and to generate additional information for recovering the state information and the row-based data.

According to an embodiment, the segmented data may be stored in each of the data servers at the interval corresponding to the number of data servers.

According to an embodiment, when update corresponding to data modification of any one of the data blocks is requested, update data may be stored in a server corresponding to the request, among the data servers, and the additional information may be updated.

According to an embodiment, when deletion of any one of the data blocks is requested, data stored in each of remaining data servers, excluding a data server corresponding to the request, may be moved forward so as to be stored in a preceding data server, among the data servers, and NULL data may be stored in the last server, among the data servers.

A distributed data management system according to an embodiment of the present invention includes data servers for storing data blocks acquired by segmenting original data, a state information server for storing state information corresponding to row-based data configured with the data blocks stored in the respective data servers, at least one additional-data server for storing additional information for recovering the row-based data and the state information, and a distributed data management server for segmenting the original data, storing the data blocks in the data servers at an interval corresponding to the number of data servers, and generating the state information and the additional information. Each of the data servers may store data blocks selected at the interval corresponding to the number of data servers in order to store the segmented data.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view illustrating a distributed data management system according to an embodiment of the present invention;

FIG. 2 is a view illustrating the process of storing original data in multiple data servers in a distributed manner according to an embodiment of the present invention;

FIG. 3 is a view illustrating a process in which data stored in a distributed manner is updated in response to a request to modify a specific data block with other information according to an embodiment of the present invention;

FIG. 4 is a view illustrating a process in which data stored in a distributed manner is updated in response to a request to delete a specific data block according to an embodiment of the present invention;

FIG. 5 is view illustrating a process in which data stored in a distributed manner is updated in response to a request to insert a specific data block according to an embodiment of the present invention;

FIGS. 6 and 7 are views illustrating the process of periodically eliminating unnecessary information that is generated during a data update process according to an embodiment of the present invention; and

FIG. 8 is a flowchart illustrating a method of operating a distributed data management system for secure management of dynamic data.

### DESCRIPTION OF THE PREFERRED EMBODIMENTS

The present invention will be described in detail below with reference to the accompanying drawings so that those having ordinary knowledge in the technical field to which the present invention pertains can easily practice the present invention.

Because the present invention may be variously changed and may have various embodiments, specific embodiments will be described in detail below with reference to the accompanying drawings. However, it should be understood that those embodiments are not intended to limit the present invention to specific disclosure forms and that they include all changes, equivalents or modifications included in the spirit and scope of the present invention. It will be understood that, although the terms “first,” “second,” etc. may be used herein to describe various elements, these elements are not intended to be limited by these terms.

These terms are only used to distinguish one element from another element. For example, a first element could be referred to as a second element without departing from the scope of rights of the present invention. Similarly, a second element could also be referred to as a first element. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Also, the terms used herein are used merely to describe specific embodiments, and are not intended to limit the present invention. A singular expression includes a plural expression unless a description to the contrary is specifically pointed out in context.

In the present specification, it should be understood that terms such as “include” or “have” are merely intended to indicate that features, numbers, steps, operations, components, parts, or combinations thereof are present, and are not intended to exclude the possibility that one or more other features, numbers, steps, operations, components, parts, or combinations thereof will be present or added. Unless differently defined, all terms used herein, including technical or scientific terms, have the same meanings as terms generally understood by those skilled in the art to which the present invention pertains. Terms identical to those defined in generally used dictionaries should be interpreted as having meanings identical to contextual meanings of the related art, and are not to be interpreted as having ideal or excessively formal meanings unless they are definitively defined in the present specification.

A method and system for secure distributed data management for dynamic data according to an embodiment of the present invention are configured such that, because a user stores the data of the user in multiple distributed servers, even though some of the servers are under attacks that can impair services, such as DDoS or the like, the user may use the original data without restriction by using information stored in the remaining servers.

A method and system for secure distributed data management for dynamic data according to an embodiment of the present invention may perform efficient data update for management of dynamic data, the original copy of which is modified in a periodic or aperiodic manner.

A method and system for secure distributed data management for dynamic data according to an embodiment of the present invention may be applied to an application environment in which a user outsources storage of his or her data so as to be stored in an external server. That is, the user transmits his or her data to an escrow server and deletes the data corresponding thereto from the local storage space of the user. Due to this characteristic of the application environment, whether the user is able to retrieve the original copy of the data from the external server becomes the most important security factor from the point of the view of the user.

With the development of technology, there is increasing demand for processing data in different places through a smart office, cloud computing, and the like, rather than in a fixed place, and the range of services related thereto is also increasing. Accordingly, it becomes more important to support dynamic data, in which the version of an original copy is continually changed, rather than static data stored and managed so as to maintain the same state.

A method and system for secure distributed data management for dynamic data according to an embodiment of the present invention may ensure the security of storage in which data is stored and prevent the availability of the data from being lowered due to stability while supporting a service for dynamically changed data from the functional aspect in an application environment in which storage of data is outsourced.

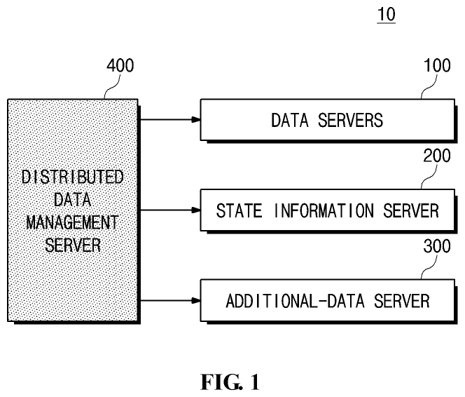

FIG. 1 is a view illustrating a distributed data management system 10 according to an embodiment of the present invention. Referring to FIG. 1, the distributed data management system 10 may include multiple data servers 100, a state information server 200, at least one additional-data server 300, and a distributed data management server 400.

The multiple data servers 100 may be implemented so as to store row-based data, which is configured with data blocks acquired by segmenting original data. Here, the respective data blocks may be stored in the multiple data servers.

The state information server 200 may be implemented so as to store state information pertaining to the row-based data. According to an embodiment, the state information may include information about whether the row-based data includes NULL data. That is, the state information may include information about whether or not the row-based data is original data.

The additional-data server 300 may be implemented so as to store additional information about the row-based data and the state information. For example, the additional information may include information that is necessary in order to recover the row-based data and the state information.

The distributed data management server 400 may be implemented so as to segment original data into multiple pieces in order to store the same in the data servers 100, to generate state information corresponding to row-based data configured with data blocks stored in the respective data servers 100, and to generate additional information for recovering the state information and the segmented data when the state information or the segmented data is damaged. According to an embodiment, the distributed data management server 400 may arbitrarily select the data servers 100, the state information server 200, and the additional-data server 300 from among multiple servers.

The distributed data management system 10 according to an embodiment of the present invention may provide flexible distributed data management for dynamic data, unlike the existing method in which successive data chunks are merely distributed and stored and some storage units for storing additional information, which is required in order to respond to loss of original data, are additionally operated along with storage in which the original data is stored.

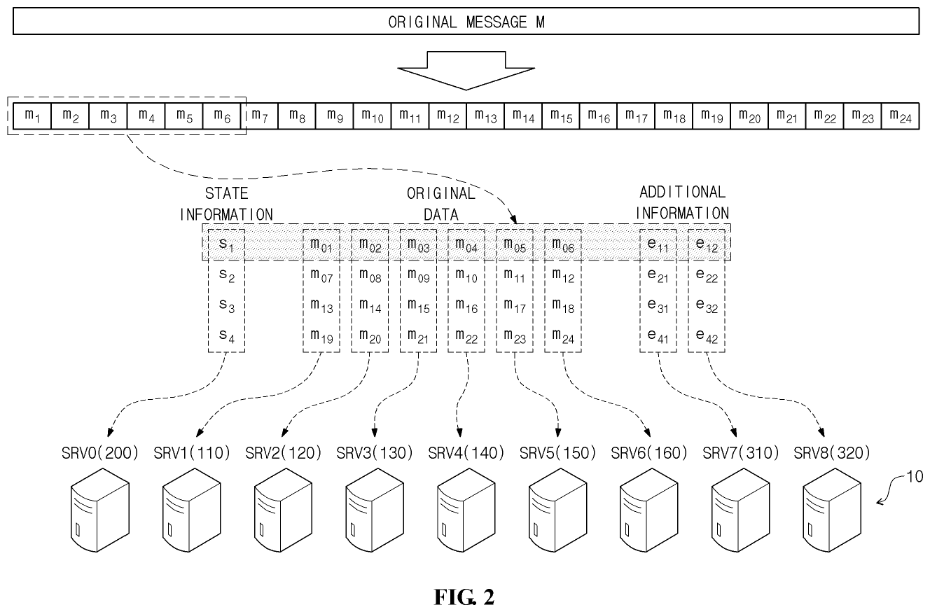

FIG. 2 is a view illustrating the process of storing original data in multiple data servers in a distributed manner according to an embodiment of the present invention. Referring to FIG. 2, multiple data servers 100 (110 to 160) may be implemented so as to store original data therein. Each of the multiple data servers 110 to 160 may be implemented so as to store messages (e.g., data blocks m₁ to m₂₄), which are acquired by segmenting an original message M into multiple pieces, according to a preset sequence. According to an embodiment, the process of storing the original data by distributing the same across the multiple servers may include generating information to be stored in each of the servers.

According to an embodiment, the original file M may be divided into segments of the same size. When the size of each segment is set so as to match a unit of information based on which modification, addition, or deletion of data is performed in a dynamic data update process, the size may be optimized for data update operations. However, it should be understood that the size of each segment is not limited thereto.

The data divided so as to be stored in each server is referred to as a data block. The divided segments may be stored in the data servers 110 to 160 for storing original data in a distributed manner.

According to an embodiment, each server may store data blocks selected at an interval corresponding to the number of servers configured to store original data, as shown in FIG. 2, rather than storing successive data blocks in the same server. For example, when six servers 110 to 160 are used for storing original data, as shown in FIG. 2, the first data server Srv1 110 may store every sixth file block, that is, m₁, m₁₊₆, m₁₊₁₂, m₁₊₁₈, and the like, which are data blocks selected at an interval of 6, which is the number of data servers. Meanwhile, it should be understood that the number of data servers for storing original data is not limited to six.

There may be two types of additional-data management servers for managing original data. The first type thereof is the state information server 200, and the second type thereof is the additional-data servers 310 and 320.

The state information server 200 may be implemented so as to store data state information for managing dynamic data. In FIG. 2, Srv0 is the state information server 200, and each of the state information blocks stored in the state information server 200 may be used as information for managing the block in the same location.

According to an embodiment, the size of a state information block may be equal to the size of a data block. The state information block may be the same size as the data block in order to create encoding data to be stored in the additional server managed for a data recovery function. However, the size of the state information block is not necessarily limited thereto.

Meanwhile, when a single state information block is not enough to represent the state information due to the amount thereof, two or more state information blocks may be used. Here, two or more servers may be used in order to store the two or more state information blocks individually. Meanwhile, FIG. 2 shows the case in which the state information is represented using only a single block.

When the original data and the state information data are set and when the number of blocks for representing the two types of information is set, as described above, additional data may be generated based on the percentage of data that needs to be retained for recovery from damage.

The additional-data servers 310 and 320 may be implemented so as to store additional information. FIG. 2 shows an example in which two additional information blocks e₁₁ and e₁₂ are required in order to respond to damage occurring in the blocks s₁, m₁ m₂, m₃, m₄, m₅, and m₆.

Meanwhile, FIG. 2 shows an example in which two additional-data servers are present. However, it should be understood that the number of additional-data servers according to the present invention is not limited thereto. In order to provide the same damage response capability, the same number of additional information blocks is required. Therefore, data blocks present in the same sequence in the respective servers are grouped in a set, as shown in FIG. 2, and dynamic data management and the ability to respond to data damage may be provided based on the set. According to an embodiment, an error-correcting code (ECC) or the like may be used as a data-processing method for responding to data damage.

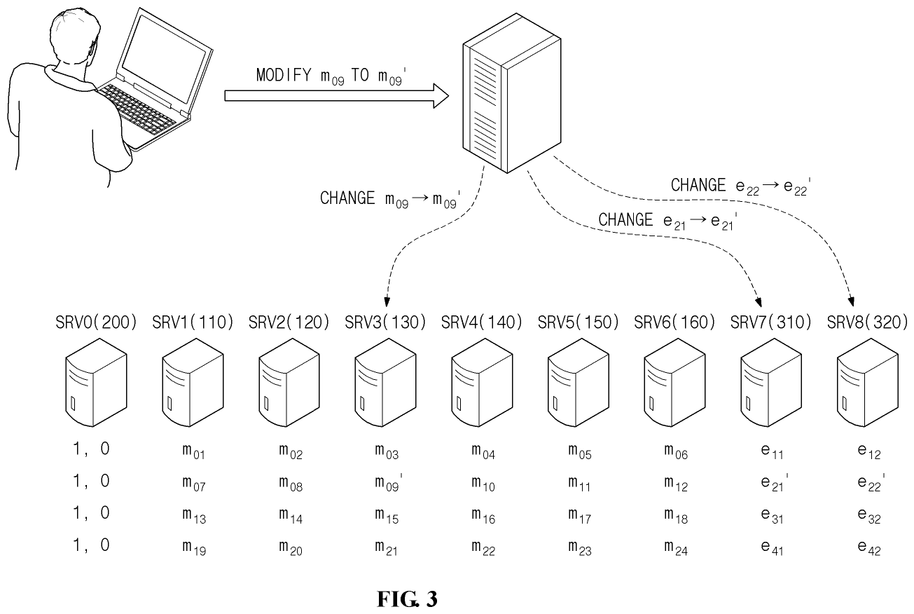

FIG. 3 is a view illustrating a process in which data stored in a distributed manner is updated in response to a request to modify a specific data block to different information according to an embodiment of the present invention. Referring to FIG. 3, the process in which data stored in a distributed manner is updated in response to a modification request (m₀₉→m_{09′}) may be performed as follows.

First, the state information stored in the state information server Srv0 200 is briefly described. The state information may fundamentally include flag information for representing a state and original-data information for representing the number of pieces of information not corresponding to original data, among the data stored in the distributed servers.

According to an embodiment, when the same rows of all of the distributed servers contain part of original data, the flag information for the row is set to ‘1’. Otherwise, the flag information may be set to ‘0’. Meanwhile, it should be understood that the value to which the flag is set is not limited thereto.

According to an embodiment, NULL data, which is unrelated to the original data, may be stored during an update process, and the original-data information may store the number of pieces of NULL data.

Using the above-described flag information and original-data information, there may be provided information about a specific row of the distributed servers in which data is stored and information about a specific row in which NULL information, which is unrelated to the data, is stored.

Also, the state information may be used as follows. When a user intends to modify information at a specific location while reading the data of the user, the user may request the server storing block data corresponding thereto to change the old information to new information. The server storing the corresponding data may simply change the existing information to the new information.

Additionally, the server storing information that is required for recovery from errors in the values stored in the same row as the row in which the changed information is included may also update its value to a new value by updating the information for recovery even when only a single block is changed. According to an embodiment, information for the update may be generated by the owner of the data. According to another embodiment, information for the update may be generated by a third entity that functions as an intermediate terminal, such as a relay server, a service agent server, or the like.

FIG. 3 shows the operation performed in response to a request to modify m₀₉ to a new value. The values stored in two servers Srv7 and Srv8 for managing information for responding to an error in the row in which m₀₉ is included may be updated (e₂₁→e_{21′}, e₂₂→e_{22′}) in response to modification of the data (m₀₉→m_{09′}). In this process, because the number of original data blocks stored in the corresponding row is not changed, the value stored in Srv0 is not changed.

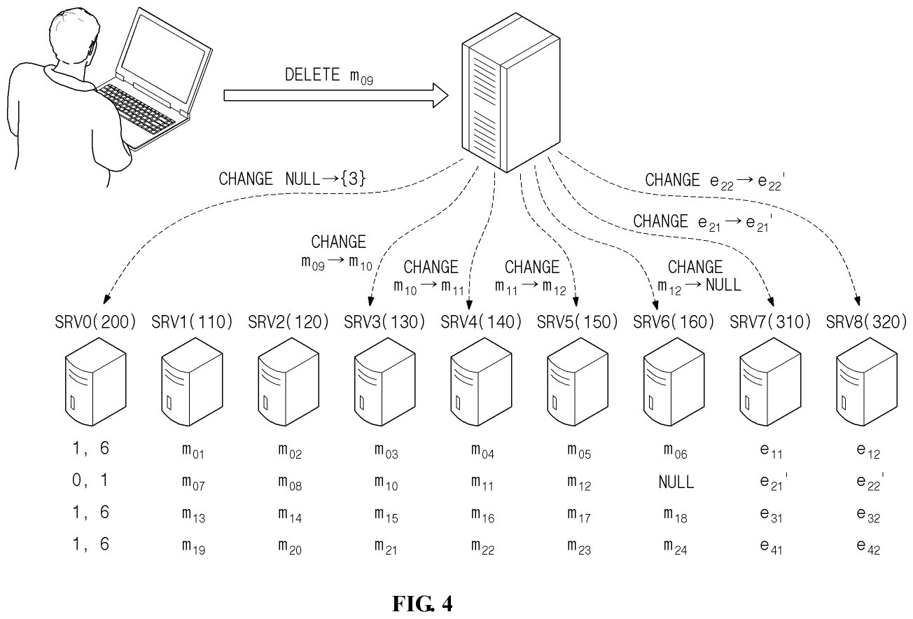

FIG. 4 is a view illustrating a process in which data stored in a distributed manner is updated in response to a request to delete a specific data block (m₀₉) according to an embodiment of the present invention. Referring to FIG. 4, when m₀₉ is deleted, the information of the row in which m₀₉ was included may be changed as follows. First, each of the remaining blocks m₁₀, m₁₁ and m₁₂, excluding m₀₉, may be stored in the preceding server, thereby replacing the old value that was stored therein. That is, the remaining blocks are moved forward one by one and stored in the distributed servers, and then NULL information may be stored in the last server.

Consequently, one piece of NULL data is stored in the corresponding row, and thus the value in the state information server Srv0 may be updated to ‘0, 1’. This indicates that the corresponding row includes NULL data, and that one piece of NULL data is included therein. Also, through the method illustrated in FIG. 3, the values stored in the error response information storage servers Srv7 and Srv8 may be updated (e₂₁→e_{21′}, e₂₂→e_{22′}) so as to match the updated data storage state.

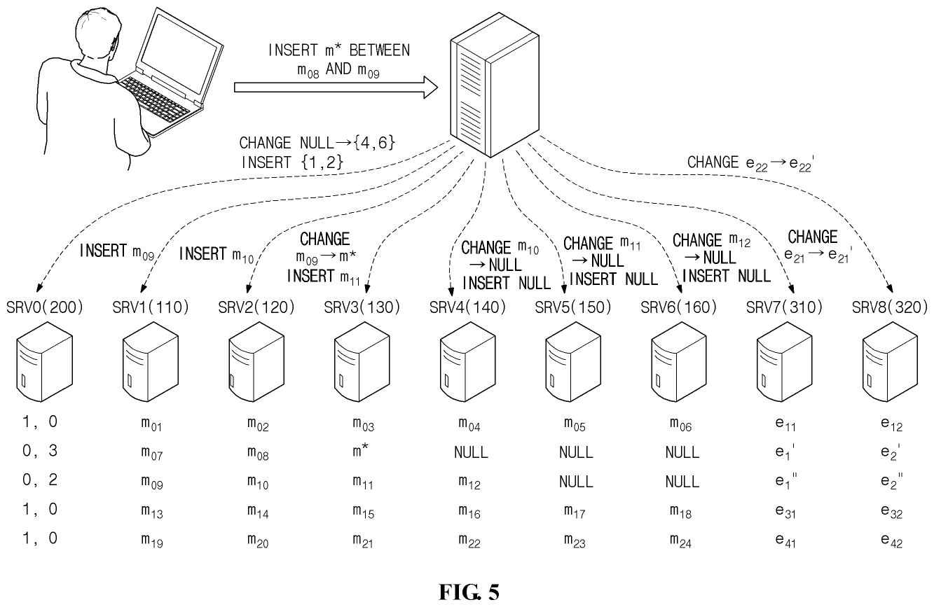

FIG. 5 is a view illustrating a process in which data stored in a distributed manner is updated in response to a request to insert a specific data block (m) according to an embodiment of the present invention. Referring to FIG. 5, when a new data block m is inserted between m₀₈ and m₀₉, the process may be performed differently depending on the space into which the new data block is to be inserted.

First, when the value in the state information server Srv0 is ‘1, 0’ because the state remains intact, as shown in FIG. 5, m is added after m₀₈, and the remainder may be filled with NULL. Also, m₀₉, m₁₀, m₁₁ and m₁₂, which were in the same row as the row in which m₀₈ is present, are moved to a newly created row and sequentially arranged from the front, and the remaining space in the corresponding row may be filled with NULL. That is, the single row is changed to two rows, and the states of the two rows may be set to ‘0, 3’ and ‘0, 2’, respectively. That is, as shown in FIG. 5, three pieces of NULL information may be stored in the upper row, and two pieces of NULL information may be stored in the lower row. Error-related data blocks for the two changed rows, including the newly added row, may be newly generated and added in the corresponding server. When space into which data can be inserted is present because NULL data is stored therein, data is merely inserted in the location at which data is intended to be added, whereby the request to insert the data may be processed.

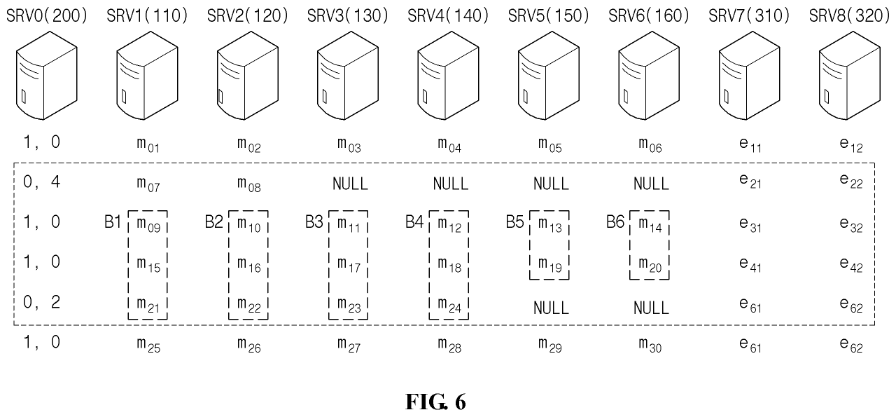

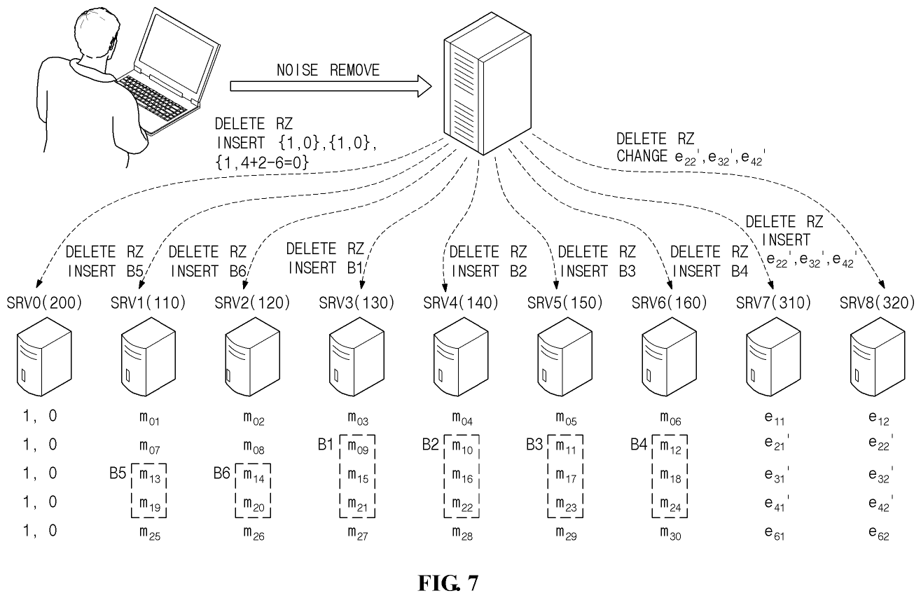

FIGS. 6 and 7 are views illustrating the process of periodically deleting unnecessary information that is generated during a data update process according to an embodiment of the present invention. Referring to FIGS. 6 and 7, an update process related to noise removal for removing removable portions from accumulated pieces of NULL data may be performed as follows. The original data state before the removal of noise, shown in FIG. 6, may be changed to the state shown in FIG. 7 after the noise is removed.

When the total number of NULL blocks present in the second and fifth rows is equal to or greater than 6, which is the number of servers, the process of removing noise may start. Here, update may be performed for the area including the two rows, which include noise. The red zone shown in FIG. 6 may correspond to the area.

The area starting from the NULL data in the first row to the end of the last row may correspond to the update area. Here, the start point and the end point may be known from the state information.

As described above, when it is confirmed from the state information that the total number of pieces of NULL data is equal to or greater than the number of servers, removal of the noise commences, and the start point at which NULL data is first found may be detected by referring to the number of NULL data blocks in the first row.

Among the information included in each server, the values required to be stored in other servers must be identified for the update. The blocks B1, . . . , B6 illustrated in FIG. 6 may correspond thereto.

According to an embodiment, the corresponding block excludes the first row and includes rows from the second row to the last row when NULL is not present in the last row. According to an embodiment, when NULL is present, NULL is excluded, and information in rows from the second row to the row immediately before the row in which NULL is present may be included in the corresponding block. For example, the block B2 includes three data block m₁₀, m₁₆ and m₂₂, starting from m₁₀ in the second row to m₂₂ in the last row because the last row is not NULL. The block B5 may include m₁₃ and m₁₉, starting from m₁₃ in the second row to m₁₉ in the row immediately before the last row because the last row is NULL. In the damage response information storage servers Srv7 and Srv8, all of the information corresponding to the red zone is deleted, and new information replaces the deleted information.

Also, the process of removing noise may be performed as follows. When information blocks are divided as described above, data change commands for update may be transmitted to the respective servers. This process is performed so as to delete one row such that the four rows change to three rows by removing noise. Accordingly, the total number of rows may be reduced.

The state information server Srv0 may update all state information to ‘1, 0’, and may then update the state information of only the last row by calculating the number of pieces of NULL information before the update and that after the update.

As shown in FIG. 7, because a total of six NULL data blocks were present, no NULL data block remains in the last row. Accordingly, state information for the last row may also be set to ‘1, 0’ like the other rows. The respective data servers Srv1 to Srv6 may sequentially store the calculated blocks B1, . . . , B6.

The blocks may be sequentially stored in such a way that the block B1 is stored in the server located apart from the first server by the number of pieces of normal data stored in the first row to which the update is applied.

As shown in FIG. 6, because two values, m₀₇ and m₀₈, which are not NULL, were stored in the second row, data blocks starting from B1 may be sequentially stored in the servers starting from Srv3, which is two servers apart from the first server. Therefore, as shown in FIG. 7, Srv4, Srv5, Srv6, Srv1 and Srv2 may store data of B2, B3, B4, B5 and B6, respectively. Before the data is stored, values corresponding to the red zone are deleted, and allocated values may be stored in the location from which the previous values are deleted. Srv7 and Srv8 may store values that are generated so as to match the changed information.

The apparatus and method for distributed data management according to an embodiment of the present invention use technology for ensuring security by storing damage response information in an additional server in order to prepare for damage to some servers in a distributed data management environment, thereby performing data distribution and management for supporting distributed data update for dynamic data, which is frequently changed.

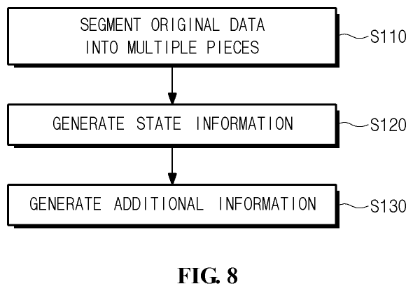

FIG. 8 is a flowchart illustrating a method of operating a distributed data management system for securely managing dynamic data. Referring to FIGS. 1 to 8, the method of operating the distributed data management system 10 may be performed as follows.

The distributed data management server 400 may segment original data into multiple pieces at step S110 in order to store the same in data servers (e.g., Srv1 to Srv6). Here, the segmented data, that is, data blocks, may be stored in the respective data servers Srv1 to Srv6 in units of rows such that each row includes a number of data blocks equal to the number of data servers.

The distributed data management server 400 may generate state information corresponding to the row-based data stored in the data servers at step S120. Here, the state information may include flag information and original-data information. The generated state information may be stored in a state information server (e.g., Srv0).

The distributed data management server 400 may generate additional information for the row-based state information and the segmented data at step S130. Here, the additional information may include an error-correcting code for recovering the row-based state information and the segmented data in the event of damage thereto. The generated additional information may be stored in additional-data servers (e.g., Srv7 and Srv8).

According to an embodiment, some or all of the steps and/or operations may be at least partially implemented or performed using one or more processors that execute instructions, programs, interactive data structures, and client and/or server components stored in one or more nonvolatile computer-readable media. Examples of the computer-readable recording media may include magnetic media such as a hard disk, a floppy disk and a magnetic tape, optical media such as a CD-ROM and a DVD, and magneto-optical media such as a floptical disk, a solid-state drive (SSD), ROM, RAM, flash memory, and the like, that is, a hardware device (volatile/nonvolatile memory) that is specially configured for storing and executing program commands/instructions.

The distributed data management server according to an embodiment of the present invention may include at least one processor and memory for storing at least one instruction executed by the at least one processor. The at least one instruction may be executed by the at least one processor so as to segment original data into multiple pieces, to generate state information for row-based data configured with data blocks, which are acquired from the segmented data and stored in respective data servers, and to generate additional information for recovering the state information and the row-based data.

The one or more nonvolatile computer-readable media may be, for example, software, firmware, hardware, and/or any combination thereof. Also, the functionality of any “module” discussed herein may be implemented in software, firmware, hardware, and/or any combination thereof.

The one or more nonvolatile computer-readable media and/or means for implementing or performing one or more operations, steps, and modules of the embodiments of the present invention may include application-specific integrated circuits (ASICs), standard integrated circuits, controllers executing suitable instructions (including microcontrollers and/or embedded controllers), field-programmable gate arrays (FPGAs), complex programmable logic devices (CPLDs), and the like, but the components that may be included therein are not limited to these examples.

A method and system for distributed data management according to an embodiment of the present invention may provide storage and update of dynamic data that is stored by being distributed to the storage of an external service provider.

A method and system for distributed data management according to an embodiment of the present invention may provide flexible distributed data management for dynamic data, unlike the existing method in which successive data chunks are merely stored in a distributed manner and in which some storage devices for storing additional information required for responding to loss of original data are additionally operated along with the storage in which the original data is stored.

A method and system for distributed data management according to an embodiment of the present invention may provide distributed data management technology that is efficiently run for dynamic data.

Meanwhile, the above description is merely of specific embodiments for practicing the present invention. The present invention encompasses not only concrete and available means but also the technical spirit corresponding to abstract and conceptual ideas that may be used as future technology.

What is claimed is:

1. A method for secure distributed data management for dynamic data, the method comprising:
segmenting original data into multiple pieces;
generating state information pertaining to row-based data configured with data blocks; and
generating additional information for recovering the state information and the row-based data,
wherein:
the data blocks, corresponding to the segmented data, are stored in data servers, and
each of the data servers stores data blocks that are selected at an interval corresponding to a number of data servers in order to store the segmented data.

2. The method of claim 1, wherein the state information is stored in at least one state information server.

3. The method of claim 1, wherein the state information includes flag information, which represents a state of the row-based data, and original-data information, which corresponds to a number of pieces of data not corresponding to the original data, among the data stored in the data servers.

4. The method of claim 3, wherein the flag information is set to a bit ‘1’ when the row-based data includes no NULL data, and is set to a bit ‘0’ when the row-based data includes NULL data.

5. The method of claim 3, wherein the original-data information includes a number of pieces of NULL data, which are stored regardless of the original data in an update process.

6. The method of claim 1, wherein the additional information is stored in at least one additional-data server.

7. The method of claim 1, further comprising:
requesting update corresponding to addition of a new data block or deletion or modification of any one of the data blocks.

8. The method of claim 7, further comprising:
changing a data block of any one of the data servers into update data; and
updating the additional information so as to match the update data.

9. The method of claim 1, further comprising:
requesting deletion of any one of the data blocks.

10. The method of claim 9, further comprising:
storing data of a data server adjacent to a data server corresponding to the data block, the deletion of which is requested; and
storing NULL data in a last data server, among the data servers.

11. The method of claim 1, further comprising:
receiving a request of insertion of data into the row-based data.

12. The method of claim 11, further comprising:
when there is space to insert a requested data in the row-based data, storing the requested data in a data server corresponding to the space.

13. The method of claim 11, further comprising:
when there is no space to insert a requested data in the row-based data, adding a new row containing space to insert to the row-based data, and storing the requested data in any one of the data servers corresponding to the space of the new row.

14. The method of claim 1, further comprising:
removing noise in order to delete removable portions from accumulated pieces of NULL data.

15. The method of claim 14, wherein removing the noise is started when a number of pieces of NULL data in at least two of the data servers is equal to or greater than the number of data servers.

16. A distributed data management server comprising:
at least one processor; and
memory for storing at least one instruction executed by the at least one processor,
wherein:
the at least one instruction is executed by the at least one processor in order to segment original data into multiple pieces, to generate state information pertaining to row-based data configured with data blocks, and to generate additional information for recovering the state information and the row-based data, and
the data blocks, corresponding to the segmented data, are stored in data servers.

17. The distributed data management server of claim 16, wherein the segmented data is stored in each of the data servers at the interval corresponding to a number of data servers.

18. The distributed data management server of claim 16, wherein, when update of any one of the data blocks is requested, update data is stored in a server corresponding to the request, among the data servers, and the additional information is updated.

19. The distributed data management server of claim 16, wherein, when deletion of any one of the data blocks is requested, data stored in each of remaining data servers, excluding a data server corresponding to the request, is moved forward so as to be stored in a preceding data server, among the data servers, and NULL data is stored in a last server, among the data servers.

20. A distributed data management system comprising:
data servers for storing data blocks acquired by segmenting original data;
a state information server for storing state information corresponding to row-based data configured with the data blocks stored in the respective data servers;
at least one additional-data server for storing additional information for recovering the row-based data and the state information; and
a distributed data management server for segmenting the original data, storing the data blocks in the data servers at an interval corresponding to a number of data servers, and generating the state information and the additional information,
wherein each of the data servers stores data blocks selected at the interval corresponding to the number of data servers in order to store the segmented data.
